(19) United States
(12) Patent Application Publication
(10) Pub. No.: US 2026/0014555 A1
(43) Pub. Date: Jan. 15, 2026

(54) METHOD FOR EXTRACTING A COMPONENT FROM A SOLUTION USING HOLLOW FIBERS

(71) Applicant: Watercycle Technologies Ltd, Manchester (GB)

(72) Inventors: Sebastian James Allender LEAPER, Manchester (GB); Ahmed ABDELKARIM, Manchester (GB)

(21) Appl. No.: 19/139,649

(22) PCT Filed: Dec. 13, 2023
(86) PCT No.: PCT/EP2023/085680

§ 371 Date: Jun. 16, 2025

(30) Foreign Application Priority Data
Dec. 14, 2022 (GB) 2218893.2

(51) Int. Cl. B01J 47/127; B01J 39/19; B01J 49/53

(52) U.S. Cl. CPC B01J 47/127; B01J 39/19; B01J 49/53

(57) ABSTRACT

Described is a method of extracting a first component from a feedstock solution comprising that first component, the method comprising steps of extraction and release. The method utilizes a fiber assembly comprising hollow fibers; each hollow fiber in the assembly has a ratio d/D which can be selected to provide beneficial effects depending on how the flow of various solutions through the assembly is conducted.

### FIELD OF THE INVENTION

The present invention relates to a method of extraction of solutes from solutions, and a device for use in such a method.

### BACKGROUND

The extraction of trace components from complex mixtures, such as precious metal from ore, is a costly process given the large volume of initial material that needs to be processed to produce a small amount of the pure trace component. This is often only economically viable for highly valuable trace components. For example gold extraction from ores is profitable even when the ores contain only a few parts per million gold. Often, it is only economically viable to extract less valuable or less common trace components by-products of another extraction process, such as in the case of extremely rare platinum-group metals such as iridium and osmium which are often extracted as a by-product in nickel extraction, or less valuable trace components such as tellurium which is extracted alongside copper.

Therefore there is interest in extraction methods applicable to the isolation of trace components at lower cost.

Ion exchange and adsorption processes (‘selective adsorption’) are being investigated as new methods of extracting trace components, they hold promise as being highly selective, energy efficient and having a lower cost than traditional methods.

Selective adsorption is the reversible exchange of like-charged ions, or like sized-species, between an insoluble solid and a solution in which the solid is immersed. This process can be tuned to be, for example, highly selective for the uptake of certain ionic species by using certain ion exchange materials. By choosing the ion exchange material to be selective for a trace component, rejection of the bulk components can be achieved allowing for the ion exchange material to be enriched with the trace component only. The trace component can then be extracted from the enriched ion exchange in a later step.

Selective adsorption processes are of interest for the extraction of trace components from feedstocks with large concentrations of impurities as they are highly selectivity for a given component. Furthermore, these processes are reversible, allowing for the selective adsorption media (such as an ion exchange medium) to be reused multiple times, reducing the need for consumable reagents. These processes also show promise for the extraction of many different resources, such as lithium, calcium, magnesium, potassium, precious metals, rare earth metals, lanthanides and actinides; organic pollutants, pharmaceutical molecules and so on.

These processes also allow for the purification of the liquid component through the selective removal of trace impurities, for example, the removal of heavy metals from drinking water.

Ion exchange processes extract trace components from solution; these feedstock solutions can be naturally occurring, such as seawater, geothermal brines and petroleum brines, or can be formed through the dissolution or leaching of ores or other solid materials.

An extraction step can be performed by flowing the feedstock solution over an ion-exchange material, wherein the ion-exchange material selectively uptakes the desired trace ion from the solution. This produces an ion-exchange material that is enriched in the trace ion. The ion-exchange material can then optionally be washed to remove impurities. The trace ion contained within the enriched ion-exchange material can then be released by flowing a release solution over the ion-exchange material (a release step). The release solution can suitably contain a high concentration of an ion that is similar to that of the trace ion; the high concentration of the release solution promotes the release of the trace ions. The trace ion enriched release solution can then be taken forward for further concentration and purification, for example, by reverse osmosis, membrane distillation, electrodialysis and the like.

Typically, the ion-exchange material is used in the form of small (approximately between 0.01-10 mm) spherical beads packed into a column through which the feedstock and release solutions are sequentially flown. This results in a device in which the solutions have to flow through a tortuous path around the beads. This causes a restriction to the flow of solutions through the device, reducing flow rates and requiring high feed pressures. This method also necessitates a step-wise process wherein continual flow of both the feedstock solution and release solution cannot occur.

For example, materials which selectively perform ion exchange of lithium are sometimes referred to as lithium ion sieves. Such lithium selective materials are of various types, such as metal organic frameworks, zeolites, layered double hydroxides or lithium metal oxides such as lithium manganese oxide (LMO).

[It will be recognised that, of course, during the ion exchange reaction a compound such as lithium manganese oxide (LMO) will be converted, to at least some degree, to hydrogen manganese oxide (HMO); it will convert back when it leaches lithium ions from a suitable feedstock.]

When a lithium-containing feedstock (suitably at raised pH) is contacted with such a selective material, in an extraction step, lithium ions from the feedstock exchange with protons in the lithium selective material; accordingly the number of protons in the feedstock is increased and the number of lithium ions in the selective material is also increased. When the lithium-enriched selective material is contacted with a release solution such as a protic acid, the ion exchange happens in the other direction: lithium ions are released into the release solution, and protons from it replace them in the selective material.

Hence a lithium-enriched release solution is obtained, which can be further processed to extract the lithium for example as a salt.

As the release solution includes far fewer impurities than the feedstock, the lithium extraction proceeds highly efficiently.

There is therefore considerable interest in an improved method and device for component extraction. The present invention has been devised in the light of the above considerations.

### SUMMARY OF THE INVENTION

The present inventors sought to provide an improved method and device for the extraction of desired components, such as lithium, from solution.

The inventors propose a method which uses a device comprising an assembly of packed hollow fibers (each fiber being an elongate tube, the fibers packed with their longitudinal directions broadly aligned). By this packing there are two ‘sets’ of fluid flow conduits through the device: one set (bore conduits) through the bores of the hollow fibers (i.e. fluid flow through the middle of the tubes), and one set (shell conduits) between the outer walls of the fibers (i.e. fluid flow around the space external to the fibers).

In the method, a feedstock solution comprising a component for extraction is fed through the assembly through the conduits mentioned above; because of the material selected for the fibers (which comprises a selective adsorption material (for example selective for desired ions for extraction) and a matrix material), the component for extraction is removed and held by the fibers. Then, after the flow of the feedstock solution is ceased, a release solution can be fed through the assembly; it is chosen such that the component for extraction held by the fibers is released into the release solution.

The feedstock and release solutions (and other optional solutions too) can be selectively fed through the bore conduits and/or the shell conduits.

In the present invention, the sizing of the fibers and the selective feed of solutions through particular conduits contributes to an improved method.

The inventors similarly propose a device comprising packed hollow fibers, comprising a selective adsorption material (for example selective for desired ions for extraction) and a matrix material, where the feedstock solution and release solutions can be selectively flown either through the bores of the fibers (bore conduits) or through the inter-fiber spaces (shell conduits), on different sides of the hollow fiber wall.

Coupled with the packing geometry of said fibers, the present invention means that the volume of release solution required can be reduced, increasing the concentration of the desired component in the release solution. This increase in concentration in the enriched release solution reduces the need for further concentration steps by, for example, reverse osmosis which can be costly.

In previous usages of hollow fiber technology, in particular hollow fiber membrane, component extraction has come by way of mechanical filtration of the feedstock through the walls of the hollow fibers. That is, a feedstock is flown in through the bore conduits (or the shell conduits) and out through the shell conduits (or bore conduits), being forced through pores of the hollow fibers by pressure and physical blocking of the ‘direct’ throughpath. This is an entirely different concept from that of the present invention.

A first aspect of the invention may provide a method of extracting a first component from a feedstock solution comprising that first component, the method comprising:
(i) an extraction step, comprising flowing the feedstock solution through a device comprising a fiber assembly of packed hollow fibers, the flow of the feedstock solution being through only the bores of the hollow fibers; or through only the volumes external to the hollow fibers; or through both the bores and the volumes external to the hollow fibers; whereby the first component is extracted from the feedstock by the hollow fibers, and
(ii) a release step, comprising flowing a release solution through only the bores of the hollow fibers; or through only the volumes external to the hollow fibers; or through both the bores and the volumes external to the hollow fibers; whereby the first component is released from the hollow fibers into the release solution,
wherein, in the release step, if the release solution is flown through both the bores and the volumes external to the hollow fibers it is flown through the bores in a first direction and through the volumes external to the hollow fibers in a second direction opposite to the first direction;
and wherein each hollow fiber in the assembly has a ratio d/D, of the inner diameter of the hollow fiber (d) and the outer diameter of the hollow fiber (D),
the ratio d/D being:
   less than or equal to 0.6 where the release solution is flown through only the bores of the hollow fibers;
   less than or equal to 0.9042 where the release solution is flown through only the volumes external to the hollow fibers;
   less than or equal to 0.6 where the release solution is flown through both the bores and the volumes external to the hollow fibers.

Where the release solution is flown through only the bores of the hollow fibers, d/D is preferably ≤0.55, ≤0.5, <0.45 or ≤0.4.

Where the release solution is flown through only the volumes external to the hollow fibers, d/D is preferably ≤0.85, ≤0.8, <0.75 or ≤0.7.

In this method, as explained herein, the packing and sizing of the fibers means that in the release step a significantly lower amount of release solution may be needed in order to contact the hollow fibers as compared to the prior art where spherical beads are used. This leads to a more efficient usage of the extraction device and a more concentrated enriched release solution, given efficiency benefits in isoltation of the extracted first component.

In preferred embodiments, same d/D preferences apply to the flow of the feedstock solution, so that corresponding improvements in extraction efficiency can be realised. That is, in preferred embodiments, the ratio d/D is:
less than or equal to 0.6 where the feedstock is flown through only the bores of the hollow fibers;
less than or equal to 0.9042 where the feedstock solution is flown through only the volumes external to the hollow fibers;
less than or equal to 0.6 where the feedstock solution is flown through both the bores and the volumes external to the hollow fibers, it being flown through the bores in a first direction and through the volumes external to the hollow fibers in a second direction opposite to the first direction; and
less than or equal to 0.5425 where the feedstock solution is flown through both the bores and the volumes external to the hollow fibers, it being flown through the bores in a first direction and through the volumes external to the hollow fibers in a second direction the same as the first direction.

Preferably, d/D is less than or equal to 0.7809 where the feedstock solution or the release solution is flown through only the volumes external to the hollow fibers.

Preferably, d/D is less than or equal to 0.4685 where the feedstock solution is flown through both the bores and the volumes external to the hollow fibers, it being flown through the bores in a first direction and through the volumes external to the hollow fibers in a second direction the same as the first direction.

For flexibility of use, d/D may suitable be less than or equal to 0.6, for example, ≤0.55, ≤0.5, ≤0.4685, ≤0.45, ≤0.4, ≤0.35, or ≤0.3. In particular, a d/D of ≤0.4685, ≤0.45, ≤0.4, ≤0.35, or ≤0.3 provides improved efficiency over prior art methods while also giving flexibility in the flow cases selected for the feedstock and release solutions.

In some preferred embodiments, in the extraction step the feedstock solution is flown through both the bores and the volumes external to the hollow fibers. In such a case, it may be that it is flown through the bores in a first direction and through the volumes external to the hollow fibers in a second direction opposite to the first direction.

In some embodiments, in the release step the release solution is flown through only the volumes external to the hollow fibers.

In some embodiments, the feedstock solution and/or the release solution are flowed through the device at an elevated temperature. The advantage of this is that the rate of selective adsorption (for example ion-exchange) is increased.

In some embodiments, the feedstock solution flown in the extraction step has a raised pH, for example pH >7; optionally the pH may be raised yet higher, for example >8, >9, >10 or >11. The raising of the pH may be done by adding any suitable chemical agent to the feedstock before flowing it in the extraction step; commonly NaOH is used.

In some embodiments the release solution comprises a protic acid. The pH of the release solution is suitably <7, for example <6, <5, <4, or <3.

In some embodiments, the feedstock solution and/or the releasing solution are flowed through the packed fiber assembly of a pressure of 1 to 5 bar, for example 1 to 3 bar or 1 to 2 bar. These pressures are generally lower than are needed for ultrafiltration (3-8 bar) or nanofiltration (5-40 bar), making the present processes more energy efficient than these other forms of filtration (=component extraction from a solution).

Also described herein is a device for extracting a first component from a solution comprising the first component, the device comprising:
a packed fiber assembly having a plurality of packed hollow fibers, the fibers each comprising a selective adsorption material which performs a selective adsorption reaction to extract the first component from the solution,
wherein the bores of the fibers are in fluid communication with each other.

In particular this device may be for use in the method of the first aspect; equally, the method of the first aspect may use such a device. Hence the preferences and features of the device expressed herein apply equally to it per se, to it for use in the methods described herein, and to the device mentioned in the discussion of such methods.

In some embodiments, the first component is an ion (first ions), and the selective adsorption material is an ion-exchange material.

It is understood in the art that hollow fibers have a central bore (hole) inside the fiber; the fiber itself (fiber wall) has an outer surface sometimes referred to as the shell. Hence, fluid can flow over a shell of a hollow fiber, or through the bore of a hollow fiber. With a plurality of packed hollow fibers (packed longitudinally), the bores form a series of bore conduits through the packed fiber assembly. Similarly, the spaces between the shells of the fibers (i.e. the volumes external to the fibers) form a series of shell conduits through the packed fiber assembly. In the present device, the bore conduits are all in fluid communication with one another. This may be achieved by providing, as the packed fiber assembly, for example, a housing containing the plurality of packed hollow fibers, with at each end of the fibers a manifold connecting the bore conduits in fluid communication. The two bore manifolds may each be provided with a bore port, to serve as an inlet (at one end) and an outlet (at the other end), the bore ports, bore manifolds and bore conduits defining a bore-side fluid flow path through the packed fiber assembly.

In such an arrangement, the shell conduits may equally be in fluid communication with one another, again by way of for example two shell manifolds (one at each end of the fibers), each with a shell port to serve as an inlet (at one end) and outlet (at the other end) to the connected shell conduits. Again, together the shell manifolds, shell ports and shell conduits together define a shell-side fluid flow path through the packed fiber assembly.

In some embodiments the shell-side fluid flow path and the bore-side fluid flow path are not in fluid communication (even in the packed fibers they are separated by the fiber wall; while there may be some capillary action wicking into the membrane there is no substantial flow through it). This permits selective flow of feedstock and release solution through only a selected one of the flow paths.

On the other hand, in some embodiments the shell-side fluid flow path and the bore-side fluid flow path are in fluid communication by connection of the shell inlet port to the bore outlet port, or the bore inlet port to the shell outlet port. These configurations allows for a bi-directional flow of a given solution (feedstock or release solution) through the packed fibers. For example, a solution may flow ‘fresh’ into the shell inlet port, through the shell conduits, out of the shell outlet port, back into the bore inlet port, through the bore conduits, then out of the bore outlet port. Or, a solution may flow ‘fresh’ into the bore inlet port, through the bore conduits, out of the bore outlet port, back into the shell inlet port, through the shell conduits, then out of the shell outlet port. This effectively lengthens (approximately doubles) the flow length over which the given solution is in contact with the hollow fibers and hence increases the efficiency of the device.

Where the hollow fibers are in the form of membranes, the combination of housing, bore and shell manifolds and ports, and the packed fibers may together be referred to as a membrane module.

The inventors observe that the packing of fibers is significantly denser than the random packing of spheres (such as the beads commonly used in the prior art), allowing for less release solution to be used to extract the product from the enriched ion-exchange/adsorption material, and the hollow fibers can provide a substantially straight path for the feedstock and release solutions to flow, thereby reducing the drop in pressure across the packed fiber assembly.

Each hollow fiber is, as is well known, in the form of an elongate fiber member with a substantially circular cross section. Stacking such fibers with their longitudinal axes aligned leads to, in cross section, a stack of (substantial) circles. Packing patterns of such circles are well know; in the present invention, hexagonal packing is preferably utilised. However it will be recognised that the packing may in practice not be perfectly hexagonal. In hexagonal close packing, a given (non-edge) fiber would be in contact with six others. In practice the fiber packing may be more similar to, in cross section, a random packing of circles. Ideally the ‘circles’ (i.e. the cross sections of the fibers) are rigidly packed.

As explained herein, the hollow fibers are in some embodiments packed inside a housing. In that case, the fibers may be packed into the housing so that they are rigidly held by the housing. Depending on the shape of the housing, the ideal (i.e. densest) packing of fibers into it will vary.

Hollow fibers have a given wall thickness. The wall defines a shell (outer surface; having a diameter equal to the outer diameter of the wall) and a bore (with a diameter equal to the inner diameter of the wall).

Herein, the outer diameter or shell diameter is referred to as “D”; the inner diameter or bore diameter is referred to as “d”.

In some preferred embodiments, the value of (d/D), of the inner diameter of the hollow fiber (d) and the outer diameter of the hollow fiber (D) is 0.4685 or less (that is, the inner diameter is 0.4685 times or less the outer diameter). More preferably, d/D is ≤0.45, ≤0.4, ≤0.35, or ≤0.3.

In other embodiments, the value of (d/D), of the inner diameter of the hollow fiber (d) and the outer diameter of the hollow fiber (D) is greater than or equal to 0.1 (that is, the inner diameter is greater than or equal to 0.1 times the outer diameter). More preferably, d/D is ≥0.15, ≥0.2 or ≥0.25.

In some embodiments, the wall thickness of the hollow fibers is equal to or less than 200 μm; for example ≤150 μm, ≤100 μm, or ≤80 μm. In some embodiments, the wall thickness of the hollow fibers is equal to or more than 20 μm; for example ≤40 μm, ≤50 μm or ≤60 μm.

The hollow fibers themselves may preferably be in the form of membranes, comprising a matrix material and a selective adsorption material. Preferably the matrix material comprises or consists of polyethersulfone (PES). The selective adsorption material may be any known in the art to have a selective adsorption or ion-exchange activity for a desired component. For example it may be an ion selective material. In some embodiments, where the intended feedstock is a lithium-containing solution, lithium metal oxides and the products formed from ion exchange of the lithium in them with hydrogen (e.g. by a pre-treatment with a protic acid, to form a hydrogen metal oxide derived from the lithium metal oxide) are particularly suitable for use as a lithium selective material held in the matrix material. Lithium manganese oxide (LMO) and hydrogen manganese oxide (HMO) derived from LMO, and lithium titanium oxide (LTO) and hydrogen titanium oxide (HTO) derived from LTO are suitable examples.

Preferably the ion selective material comprises LTO or HTO. That is particularly the case where the matrix material is PES.

The invention includes the combination of the aspects and preferred features described except where such a combination is clearly impermissible or expressly avoided. For example, features of the hollow fibers discussed as part of the first aspect of the invention can be applied equally to the hollow fibers discussed as part of the second aspect of the invention.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

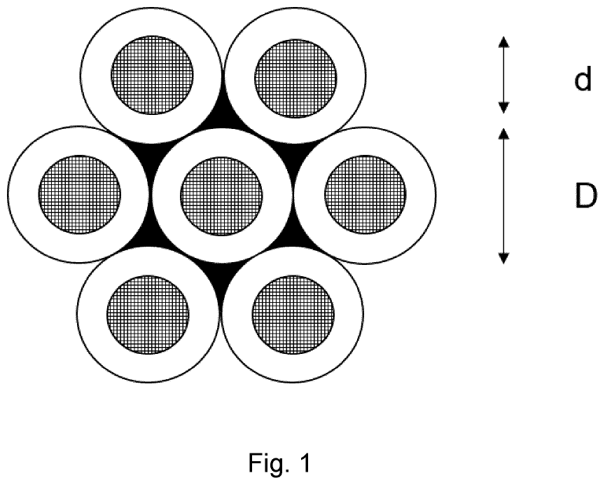

FIG. 1 shows the idealised hexagonal close packing arrangement of hollow fibers (that is, it is a schematic cross sectional view of a small part of the fiber assembly). As can be seen, the internal, bore-side volume is that running through the centre of the fibers. This is referred to herein as the bore-side volume, the bores, the bore conduit and so on. In FIG. 1 it is shown in solid black. The external, shell-side volume is that between the individual fibers. This is referred to herein as the shell-side volume or shell conduit; the volume external to the fibers. In FIG. 1 it is shown in cross-hatching.

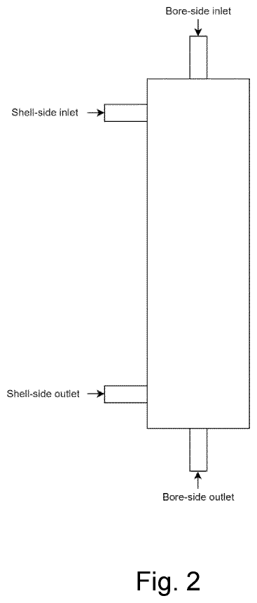

FIG. 2 shows an exemplary device described herein. In FIG. 2, it can be seen that there are separate inlets for the shell-side and bore-side portions (that is, the shell conduits and the bore conduits) of the hollow fiber.

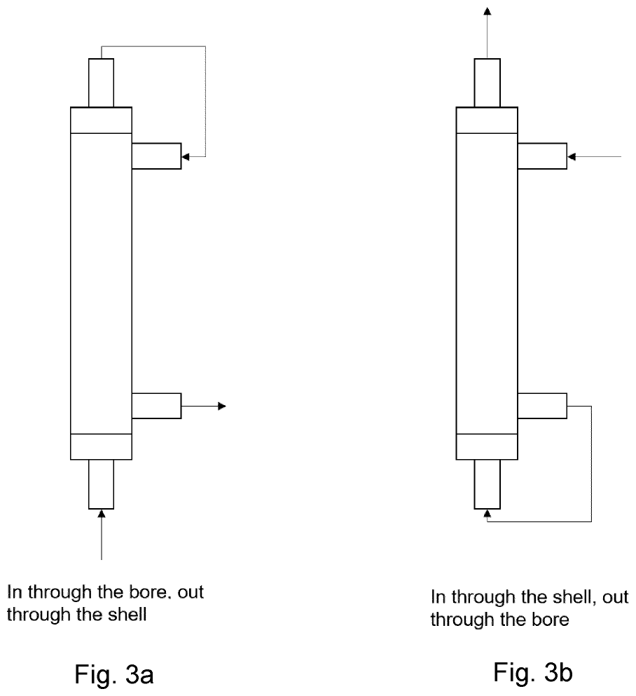

FIG. 3 shows two exemplary flow patterns through a device as described herein. In FIG. 3a, the bore outlet is connected to the shell inlet. In FIG. 3b, the shell outlet is connected to the bore inlet.

### DEVICE CONSTRUCTION

Suitably the hollow fibers can be contained within an outer casing or housing. This provides a containment for the solution when flowed through the volume external to the fibers and defines the volume external to the fibers. It may suitably have, in its longitudinal direction, a hexagonal cross section to best match the packing of the fibers within it.

The volume(s) external to the fibers is taken to mean the interstitial volume(s) between and around the hollow fibers; that is, the inter-fiber volume. In FIG. 1 this is shaded solid black.

The way in which the internal volumes of the fibers (i.e. the bores; shaded with cross-hatching in FIG. 1) are connected is not particularly limited, provided that it allows for a solution to be concurrently flowed through the fibers. For example, a manifold (or pair of manifolds, one at each end of the fibers) may be provided which fluidly join(s) all the bores of the fibers. A similar manifold (or manifolds) may be provided which join(s) all the volumes external to the fibers. By selective supply to one of these manifolds, a feedstock or release solution can selectively be delivered to and flown through the device using only the bores or only the external volumes, or both.

A manifold connecting all the bores of the fibers at one of their ends may be provided with an inlet port; a similar manifold connecting the bores at the other end of the fibers may be provided with an outlet port. As illustrated in FIG. 2, these may be termed the bore-side inlet and the bore-side outlet respectively.

Equally, a manifold connecting all the volumes external to the fibers at one of their ends may be provided with an inlet port; a similar manifold connecting all the volumes external to the fibers at the other end of the fibers may be provided with an outlet port. As illustrated in FIG. 2, these may be termed the shell-side inlet and the shell-side outlet respectively.

Each inlet can be selectively supplied with feedstock solution and/or release solution, according to one of the protocols discussed herein, to provide selective flow of those solutions through certain spaces in the fiber assembly.

Output from the outlets are the relevant solutions post-modification by the fiber assembly. That is, a release solution enriched with the first component (such as an ion released from the ion-exchange material); or a feedstock solution depleted of the first component (for example exchanged with protons to be held by an ion-exchange material).

### Fiber Packing

Suitably, the fibers within the device of the invention are packed hexagonally; that is, substantially each fiber is surrounded by and comes into contact with 6 other fibers. Such packing is well known and understood mathematically; it is illustrated schematically in FIG. 1. Those fibers at the edge of the hexagonally-packed mass of fibers may contact fewer than 6 other fibers. In some cases, the hexagonal packing is not perfect, resulting in some fibers not being in contact with 6 other fibers. In some embodiments, the proportion of fibers that are hexagonally packed in relation to the total fibers is ≥90%, optionally ≥95%, optionally ≥99%.

The ideal close-packing of spherical beads of an ion-exchange material results in a density (volume of beads in a given volume) of approximately 74% (that is, approximately 26% of the space is “dead space” not filled by the spheres; it is this space into which the feedstock and release solution can flow in the ion exchange process described herein). However, a column or other volume is in real life typically randomly packed with beads, resulting in an approximate average density of 64%; that is, 36% of the column will be “dead space” through which the feedstock or releasing solution must flow in order to contact all of the desired surface area of the beads.

The remaining 64% is ‘active material’ in the form of the beads. The ratio of ‘dead space’ to ‘active material’ is 36%/64%=0.5625.

This ratio can be used as a proxy for the efficiency of the packed material. To achieve an improved efficiency over that of the above described spherical packing of beads, the ratio of ‘dead space’ to ‘active material’ must be lower than 0.5625. [The ‘active material’ in the present invention is, evidently, the membrane material.]

By doing so, a smaller amount of solution can achieve the same effect; or the same volume of solution can be more efficiently used. The larger the free volume, or dead space, the larger the required volume of release solution to contact the active material. This larger volume of release solution results in a lower concentration of the released species. It is therefore favourable to reduce the amount of dead space, and especially the ratio of dead space to membrane area.

A cross-sectional analysis of the present packed fibers can be used for calculation. Since the cross section is uniform along the length of the packed fibers it can be removed from a ‘3D’ calculation to simplify.

In hexagonally close-packed hollow fibers, the maximum dead or void space between the fibers (i.e. between the shells of the hollow fibers in the present invention; the ‘shell conduits’) is 9.31% (=(1−0.9069)*100%, where 0.9069 is the ideal packing ratio for hexagonally packed circles) of the whole. The dead or void space within the fibers (i.e. the bores) is [0.9069*([d²/D²])]*100% of the whole.

In more detail: 90.69% of the whole is made up of the membrane+the bore (i.e., π(D/2)²). The bore area is π(d/2)².

The bore makes up [π(d/2)²]/[π(D/2)2]=(d²/D²) of the membrane+bore area, which is 90.69% of the whole. Therefore the bore volume is (d²/D²)*90.69% of the whole.

The membrane area is π[(D/2)²−(d/2)²]. The membrane makes up π[(D/2)²−(d/2)²]*90.69% of the whole.

The ratio of bore volume to membrane volume is [d²/D²]/π[(D/2)²−(d/2)²].

The ratio of shell conduit volume to membrane volume is 9.31%/π[(D/2)²−(d/2)²]*90.69%.

The ratio of bore volume+shell conduit volume to membrane volume is [(d²/D²)*90.69%+9.31%]/π[(D/2)²−(d/2)²]*90.69%.

In randomly packed hollow fibers, the maximum dead or void space between the fibers (i.e. between the shells of the hollow fibers in the present invention; the ‘shell conduits’) is 18% (=(1−0.82)*100%, where 0.82 is the packing ratio for randomly packed circles, see “The random packing of circles in a plane”, Kausch, H. H. et al, Journal of Colloid and Interface Science, Volume 37, Issue 3, November 1971, pages 603-611) of the whole. The dead or void space within the fibers (i.e. the bores) is [0.82*([d²/D²])]*100% of the whole.

In more detail: 82% of the whole is made up of the membrane+the bore (i.e., π(D/2)²). The bore area is π(d/2)².

The bore makes up [π(d/2)²]/[π(D/2)²]=(d²/D²) of the membrane+bore area, which is 82% of the whole. Therefore the bore volume is (d²/D²)*82% of the whole.

The membrane area is π[(D/2)²−(d/2)²]. The membrane makes up π[(D/2)²−(d/2)²]*82% of the whole.

The ratio of bore volume to membrane volume is [d²/D²]/π[(D/2)²−(d/2)²].

The ratio of shell conduit volume to membrane volume is 18%/π[(D/2)²−(d/2)²]*82%.

The ratio of bore volume+shell conduit volume to membrane volume is [(d²/D²)*82%+18%]/π[(D/2)²−(d/2)²]*82%.

Within packed hollow fibers, as mentioned above, the void or dead space depends on the internal diameter of the hollow fiber. The effective void space, and hence the ratio of dead space to membrane or active material and thus the preferred sizing of the fibers, can be calculated for three flow cases.

### For Hexagonal Packing:

(i) In the first flow case, the (for example) release solution is flown through the shell conduits and the bore conduits (primarily, in the same direction at the same time).

To achieve the same overall density as randomly packed spheres (36% dead space; ratio of dead space to active material=0.5625), the hollow fiber can comprise up to 26.69% dead space attributable to the bore (36% for prior art spheres, minus the 9.31% attributable to the inter-fiber void space). This is achieved when the hollow fibers have a d/D value of 0.5425.

In more detail: the available space (100%) is made up of three volumes: the volume attributable to the inter-fiber void space (9.31%), the volume attributable to the membrane/fiber material itself, and the volume attributable to the bores of the fibers.

For the bores to provide 26.69% of the whole as dead space, the bore volume of the whole (d²/D²)*90.69%=26.69%.

Hence d/D=0.5425.

Looked at differently, to be considered more efficient than the spherical bead case, the ratio of dead space to membrane material must improve upon that of the spherical bead case.

Therefore, (the bore volume as a percentage of the whole+9.31%)/[90.69%−the bore volume as a percentage of the whole] must be 0.5625 or less. Thus the bore volume as a percentage of the whole must be less than 26.69%. The bore volume is (d²/D²)*90.69% of the whole. Accordingly, to improve upon the ratio of dead space to active material provided by the spherical bead embodiment, d/D must be 0.5425 or less.

Accordingly hollow fibers with a d/D value ratio of 0.5425 or smaller (for example, ≤0.54, ≤0.5, ≤0.45, or ≤0.4) are preferred as they allow for fibers with the same or higher density of ion-exchange material when compared to spherical beads with the advantage that a smaller volume of the given solution is required, as the void space is compartmentalised rather than being contiguous.

For example, in the case of close-packed hollow fibers with d/D value of less than 0.5425, release solution can be flown through either or both the internal volumes of the hollow fibers (through the bore conduits) or the volume external to the hollow fibers (through the shell conduits) at the same time in the same direction while still achieving superior results to the spherical beads of the prior art.

(ii) In the second flow case, the (for example) release solution is flown through the bore conduits only. In this instance, the dead space to be considered is the bore only, since that is where potentially underutilised (for example) release solution will be present.

Accordingly, the bores alone can provide up to 36% dead space (of the bore+membrane; again, the inter-fiber area is ignored as there is no flow there). Hence (d²/D²)=36%. This leads to a ratio d/D of 0.6.

Accordingly hollow fibers with a d/D value ratio of 0.6 or smaller (for example, ≤0.55, ≤0.5, ≤0.45 or ≤0.4) are preferred as they allow for fibers with the same or higher density of ion-exchange material when compared to spherical beads with the advantage that a smaller volume of releasing solution is required, as the void space is compartmentalised rather than being contiguous.

For example, in the case of close-packed hollow fibers with d/D value of less than 0.63, release solution can be flown through the internal volumes of the hollow fibers (through the bore conduits) only while still achieving superior results to the spherical beads of the prior art.

Looked at differently, to be considered more efficient than the spherical bead case, the ratio of dead space to membrane material must improve upon that of the spherical bead case.

Therefore, the bore volume as a percentage of the whole/[90.69%−the bore volume as a percentage of the whole] must be 0.5625 or less. Thus the bore volume as a percentage of the whole must be less than 32.64%. The bore volume is (d²/D²)*90.69% of the whole. Accordingly, to improve upon the ratio of dead space to active material provided by the spherical bead embodiment, d/D must be 0.6 or less.

(iii) In the third flow case, the (for example) release solution is flown through the shell conduits only. In this instance, the dead space to be considered is the inter-fiber space only, since that is where potentially underutilised (for example) release solution will be present.

This dead space accounts for 9.31% of the total area. However, to be considered more efficient than the spherical bead case, the ratio of dead space to membrane material must improve upon that of the spherical bead case.

Therefore, 9.31%/[90.69%−the bore volume as a percentage of the whole] must be 0.5625 or less. The bore volume is (d²/D²)*90.69% of the whole. Accordingly, to improve upon the ratio of dead space to active material provided by the spherical bead embodiment, d/D must be 0.9042 or less.

### For Random Packing:

(i) In the first flow case, the (for example) release solution is flown through the shell conduits and the bore conduits (primarily, in the same direction at the same time).

To achieve the same overall density as randomly packed spheres (36% dead space; ratio of dead space to active material=0.5625), the hollow fiber can comprise up to 18% dead space attributable to the bore (36% for prior art spheres, minus the 18% attributable to the inter-fiber void space). This is achieved when the hollow fibers have a d/D value of 0.4685.

In more detail: the available space (100%) is made up of three volumes: the volume attributable to the inter-fiber void space (18%), the volume attributable to the membrane/fiber material itself, and the volume attributable to the bores of the fibers.

For the bores to provide 18% of the whole as dead space, the bore volume of the whole (d²/D²)*82%=18%.

Hence d/D=0.4685.

Looked at differently, to be considered more efficient than the spherical bead case, the ratio of dead space to membrane material must improve upon that of the spherical bead case.

Therefore, (the bore volume as a percentage of the whole+18%)/[82%−the bore volume as a percentage of the whole] must be 0.5625 or less. Thus the bore volume as a percentage of the whole must be less than 18%. The bore volume is (d²/D²)*82% of the whole. Accordingly, to improve upon the ratio of dead space to active material provided by the spherical bead embodiment, d/D must be 0.4685 or less.

Accordingly hollow fibers with a d/D value ratio of 0.4685 or smaller (for example, ≤0.45, ≤0.4, ≤0.35 or ≤0.3) are preferred as they allow for fibers with the same or higher density of ion-exchange material when compared to spherical beads with the advantage that a smaller volume of the given solution is required, as the void space is compartmentalised rather than being contiguous.

For example, in the case of randomly packed hollow fibers with d/D value of less than 0.4685, release solution can be flown through either or both the internal volumes of the hollow fibers (through the bore conduits) or the volume external to the hollow fibers (through the shell conduits) at the same time in the same direction while still achieving superior results to the spherical beads of the prior art.

(ii) In the second flow case, the (for example) release solution is flown through the bore conduits only. In this instance, the dead space to be considered is the bore only, since that is where potentially underutilised (for example) release solution will be present.

Accordingly, the bores alone can provide up to 36% dead space (of the bore+membrane; again, the inter-fiber area is ignored as there is no flow there). Hence (d²/D²)=36%. This leads to a ratio d/D of 0.6.

Accordingly hollow fibers with a d/D value ratio of 0.6 or smaller (for example, ≤0.55, ≤0.5, ≤0.45 or ≤0.4) are preferred as they allow for fibers with the same or higher density of ion-exchange material when compared to spherical beads with the advantage that a smaller volume of releasing solution is required, as the void space is compartmentalised rather than being contiguous.

For example, in the case of packed hollow fibers with d/D value of less than 0.63, release solution can be flown through the internal volumes of the hollow fibers (through the bore conduits) only while still achieving superior results to the spherical beads of the prior art.

Looked at differently, to be considered more efficient than the spherical bead case, the ratio of dead space to membrane material must improve upon that of the spherical bead case.

Therefore, the bore volume as a percentage of the whole/[82%−the bore volume as a percentage of the whole] must be 0.5625 or less. Thus the bore volume as a percentage of the whole must be less than 29.52%. The bore volume is (d²/D²)*82% of the whole. Accordingly, to improve upon the ratio of dead space to active material provided by the spherical bead embodiment, d/D must be 0.6 or less.

(iii) In the third flow case, the (for example) release solution is flown through the shell conduits only. In this instance, the dead space to be considered is the inter-fiber space only, since that is where potentially underutilised (for example) release solution will be present.

This dead space accounts for 18% of the total area. However, to be considered more efficient than the spherical bead case, the ratio of dead space to membrane material must improve upon that of the spherical bead case.

Therefore, 18%/[82%−the bore volume as a percentage of the whole] must be 0.5625 or less. The bore volume is (d²/D²)*82% of the whole. Accordingly, to improve upon the ratio of dead space to active material provided by the spherical bead embodiment, d/D must be 0.7809 or less.

From the above it can be seen that advantageously d/D is 0.9042 or less is employed, which allows for improved efficiency by flow through the shell conduits with ideal hexagonal packing. To allow for improved efficiency by flow through the bore conduits, a d/D of 0.6 or less is employed. To allow for improved efficiency by flow through both the bore conduits and the shell conduits (at the same time, in the same direction) where there is hexagonal close packing, a d/D of 0.5425 or less is employed.

With a more practical randomised packing, a d/D value of 0.7809 can be employed, which allows for improved efficiency by flow through the shell conduits with ideal hexagonal packing. To allow for improved efficiency by flow through the bore conduits, a d/D of 0.6 or less is employed. To allow for improved efficiency by flow through both the bore conduits and the shell conduits (at the same time, in the same direction) where there is random packing, a d/D of 0.4685 or less is employed.

It can be seen that a lower d/D value, for example <0.5 or <0.45 (in particular, ≤0.4685, ≤0.45, ≤0.4, ≤0.35, or ≤0.3), allows for a wider range of usages (flow path combinations) for the present invention, and a greater flexibility in terms of fiber packing. Accordingly such values may be preferred in some embodiments.

However it is also noted that as d/D reduces (i.e. the bore becomes smaller; the walls of the membrane become thicker) flow through the bore may become restricted by a pressure drop.

Therefore the flow case (iii) discussed above, where the (for example) release solution is flown through the shell conduits only, may be preferred in some circumstances as it allows for efficiency improvements in terms of dead space/solution utility while also not limiting bore-side flow by pressure drop. In such instances, a d/D ratio of 0.5-0.9, for example 0.6-0.7, may be preferred.

It is also noted that, by flowing through the bores in one direction and the volumes external to the fibers (shell conduits) in the other direction, each direction can be considered independently as part of an extended flow path. Hence, effectively, flow case (ii) applies for some period and then flow case (iii) applies for some period. In this instance efficiency improvements can be yet further obtained with a d/D equal to or lower than the smallest value (between (ii) and iii); that is, 0.6) with the added advantage of an extended flow path length.

Thus in more preferred embodiments of the present invention, d/D is ≤0.6, especially where a solution is flowed through the bores in one direction and the volumes external to the fibers (shell conduits) in the other direction.

d/D may suitably be greater than or equal to 0.1, for example ≥0.15, ≥0.2 or ≥0.25. This can help avoid the pressure drop mentioned above.

### Fiber Dimensions

The outer diameter (D) and the inner diameter (d) of the fiber is not particularly limited; as explained above, the advantages of the invention step from the packing arrangement, ratio of dead space to membrane material, and the wall thickness and/or value of d/D that are important. However, a suitable range of d is 100-1000 μm; a suitable range for D is 200-2000 μm. If d is too small, there may be an unacceptable pressure drop when flowing through the fiber bores.

The wall thickness (that is, half the difference between the outer diameter and inner diameter; [D−d]/2) is not particularly limited; in some embodiments it is 20-200 μm.

### Fiber Material

The hollow fibers themselves comprise (that is, preferably are in the form of) membranes, comprising a matrix material and a selective adsorption material such as an ion selective material. The matrix material may suitably be a polymeric matrix material. The selective adsorption material is not particularly limited; it can be chosen appropriate to the component which one intends to extract from the feedstock. For example, it may be a lithium selective material in it is intended to extract lithium from the feedstock.

In some preferred embodiments the matrix material comprises one or more selected from: polysulfone (PSU), polyethersulfone (PES), polyketone (PK), polyetherketone (PEK), polyetheretherketone (PEEK), polyetherketoneketone (PEKK), polyvinylidene difluoride (PVDF), polypropylene (PP), and polyimide. In some embodiments it consists of one of those. PES is particularly preferred. Therefore preferably the matrix material comprises or consists of PES.

Where a lithium ion selective material is included, it may be for example a metal organic framework, a zeolite, a layered double hydroxides or a metal oxide. Lithium metal oxides and the hydrogen equivalents derived from them are particularly suitable for use as a lithium selective material held in the matrix material. Lithium manganese oxide (LMO) and hydrogen manganese oxide (HMO) derived from LMO, and lithium titanium oxide (LTO) and hydrogen titanium oxide (HTO) derived from LTO are suitable. [It will be recognised that, of course, during the ion exchange reaction a compound such as lithium manganese oxide (LMO) will be converted, to at least some degree, to hydrogen manganese oxide (HMO) on contact with the release solution; it will convert back when it leaches lithium ions from a suitable feedstock. Accordingly the ion selective material may be accurately described as both LMO and HMO depending on its state of lithium ion loading. The applies mutatis mutandis to LTO and HTO, of course.]

Preferably the ion selective material comprises LTO or HTO derived from LTO. That is particularly the case where the matrix material is PES.

### Method of Use

As described herein, the present invention relates to a method of extracting a first component from a feedstock solution comprising that component, the method comprising:
(i) an extraction step, comprising flowing the feedstock solution through only the bores of the hollow fibers; or through only the volumes external to the hollow fibers; or through both the bores and the volumes external to the hollow fibers; and
(ii) a release step, comprising flowing a release solution through only the bores the hollow fibers; or through only the volumes external to the hollow fibers; or through both the bores and the volumes external to the hollow fibers.

Clearly in such a method the device is chosen/formed such that it comprises a material, such as a selective adsorption material, that selectively adsorbs or ion-exchanges to extract the desired component from the feedstock solution. Suitable materials for the fibers are mentioned above.

To make best use of the hollow nature of the fibers, at least one of the feedstock solution and the release solution is flowed through at least the bores.

The feedstock solution may be any solution containing the desired component for extraction (the first component; for example, first ions). For example, in the case of lithium extraction, it may be any solution comprising lithium ions, for example a geothermal brine or similar.

During operation, in the case of use of a lithium selective ion exchange material, in the extraction step typically a (for example lithium-containing) feedstock solution is contacted with the hollow fibers, often with its pH slightly raised (that is, pH >7; optionally the pH may be raised yet higher, for example >8, >9, >10 or >11). The raising of the pH may be done by adding any suitable chemical agent; commonly NaOH is used. This causes the feedstock solution to be, effectively, proton-poor, promoting exchange of protons in the ion-exchange material with the first ions (e.g. lithium ions) in the feedstock solution.

The extraction step, as well as suitably being conducted at raised pH, may also or instead suitably be conducted at raised temperature (that is, >room temperature; for example >30° C., >40° C., >50° C., >60° C. or >70° C.).

These conditions (raised pH and raised temperature) each contribute to enhanced ion exchange between the feedstock solution and the ion-exchange material.

In the release step, a release solution is used to perform a further reaction to release the first component from the hollow fibers (for example, where they comprise a selective adsorption material). In some embodiments it is replaced with, for example, protons. This ‘regenerates’ the material ready for further extraction of the first component from the feedstock. For example this may be an ion exchange reaction, where first ions are released and replaced with protons from the release solution.

Hence, the release solution is suitably one which comprises a protic acid. The pH of the release solution (which is generally aqueous) depends of course on the acid included in it and how much is included; generally, it has a pH<7, for example <6, <5, <4, or <3.

A typical acid used to release the lithium ions is HCl. When HCl is contacted with the selective material, lithium ions are removed from it and a solution is formed that comprises lithium chloride (typically with small amounts of impurities).

This lithium chloride solution can then be converted into industrially useful materials such as lithium hydroxide and lithium carbonate at a later stage.

Similar processes occur when other acids are used. Suitable acids include citric acid. Citric acid is preferable as it is a relatively easily obtainable, low toxicity acid which provides lithium citrate solutions that are readily processed.

In the extraction step, the feedstock solution can be flown through any combination of the bore conduits or the shell conduits (i.e. through the hollow fibers themselves or through the spaces between the fibers; or both).

Flowing through both conduits allows maximum contact of the feedstock with the selective adsorption material, and hence maximum extraction of the desired component from the feedstock. It is thus preferable that the feedstock solution is, in the extraction step, flown through both the bores and the volumes external to the hollow fibers.

Such a flow may suitably be unidirectional (that is, the feedstock flows through (i) the bores and (ii) the volumes external to the hollow fibers in the same direction) or bidirectional (that is, the feedstock flows through the bores in one direction and the volumes external to the hollow fibers in the opposite direction).

The release solution may suitably be flown twice through the fiber assembly: once through only the bores of the hollow fibers, and once through only the volumes external to the hollow fibers.

Where the release solution is flown twice through the fiber assembly (that is, for example, in a bidirectional flow pattern: the release solution flows through the bores in one direction and the volumes external to the hollow fibers in the opposite direction) it may suitably be flown through the volumes external to the hollow fibers (shell side) first, and then flown through the bores. By such a flow pattern, both sides of the membrane (i.e. both sides of the wall of the hollow fiber) can be contacted with the release solution, while minimising the amount of release solution needed for that as explained above.

In some embodiments the shell-side fluid flow path and the bore-side fluid flow path are in fluid communication by connection of the shell inlet port to the bore outlet port (FIG. 3a), or the bore inlet port to the shell outlet port (FIG. 3b). These configurations allow for a bi-directional flow of a given solution (feedstock or release solution) through the packed fibers. For example, a solution may flow ‘fresh’ into the shell inlet port, through the shell conduits, out of the shell outlet port, back into the bore inlet port, through the bore conduits, then out of the bore outlet port (FIG. 3b). This is particularly preferred for the flow of the release solution. Or, a solution may flow ‘fresh’ into the bore inlet port, through the bore conduits, out of the bore outlet port, back into the shell inlet port, through the shell conduits, then out of the shell outlet port (FIG. 3a).

In some embodiments, the method comprises an additional washing step, involving washing the fibers with a rinse solution such as water (e.g. deionized water) performed after either the extraction step (i.e. after step (i)) or the release step (i.e. after step (ii)), or performed after both the extraction step and the release step (i.e. after both step (i) and step (ii)). When performed after the extraction step, this washing step removes any impurities left on the surface of the hollow fibers. When performed after the release step, this washing step ensures all of the enriched species is removed from the ion exchange material.

The rinse solution may be flown through only the bores of the hollow fibers; or through only the volumes external to the hollow fibers; or through both the bores and the volumes external to the hollow fibers.

It is advantageous to minimise the amount of rinse solution used, to avoid dilution of the desired product and to increase efficiency. It therefore may be preferred to flow the rinse solution through the fiber assembly twice (that is, for example, in a bidirectional flow pattern: the rinse solution flows through the bores in one direction and the volumes external to the hollow fibers in the opposite direction). The rinse solution may suitably be flown through the volumes external to the hollow fibers (shell side) first, and then flown through the bores.

Alternatively to the washing step, or in addition to it, there may be included a ‘backflushing’ step. In such a step, a compressed gas such a N₂ is flown through the hollow fiber assembly, in particular through either only the bores or only the volumes external to the hollow fibers. The N₂, at increased pressure, passes through the membrane, removing any trapped liquid from the feedstock, release or rinse solution(s), depending on when the backflushing step is carried out.

In preferred embodiments, the backflushing step is carried out after step (ii), so that release solution loaded with the first component can be removed without diluting it (as would occur in a washing step).

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A method of extracting a first component from a feedstock solution comprising that first component, the method comprising:
(i) an extraction step, comprising flowing the feedstock solution through a device comprising a fiber assembly of packed hollow fibers, the flow of the feedstock solution being through only the bores of the hollow fibers; or through only the volumes external to the hollow fibers; or through both the bores and the volumes external to the hollow fibers; whereby the first component is extracted from the feedstock by the hollow fibers, and
(ii) a release step, comprising flowing a release solution through only the bores of the hollow fibers; or through only the volumes external to the hollow fibers; or through both the bores and the volumes external to the hollow fibers; whereby the first component is released from the hollow fibers into the release solution,
wherein, in the release step, if the release solution is flown through both the bores and the volumes external to the hollow fibers it is flown through the bores in a first direction and through the volumes external to the hollow fibers in a second direction opposite to the first direction;
and wherein each hollow fiber in the assembly has a ratio d/D, of the inner diameter of the hollow fiber (d) and the outer diameter of the hollow fiber (D),
the ratio d/D being:
less than or equal to 0.6 where the release solution is flown through only the bores of the hollow fibers;
less than or equal to 0.9042 where the release solution is flown through only the volumes external to the hollow fibers;
less than or equal to 0.6 where the release solution is flown through both the bores and the volumes external to the hollow fibers.

2. A method according to claim 1 wherein the first component is an ion and the hollow fibers comprise a selective adsorption material which performs a selective adsorption reaction to extract the first component from the feedstock solution, wherein the selective adsorption material is an ion-exchange material.

3. A method according to claim 1, wherein the value of d/D is less than 0.6, preferably ≤0.54, ≤0.5, ≤0.45, or ≤0.4.

4. A method according to claim 1, wherein d/D is greater than or equal to 0.1, preferably ≥0.15, ≥0.2 or ≥0.25.

5. A method according to claim 1, wherein the hollow fibers are in the form of membranes comprising a matrix material and a selective adsorption material.

6. A method according to claim 5, wherein the matrix material comprises polyethersulfone and the selective adsorption material comprises a lithium-ion selective adsorption material.

7. A method according to claim 5, wherein the hollow fibers comprises polyethersulfone as the matrix material and at least one of lithium manganese oxide, hydrogen manganese oxide derived from lithium manganese oxide, lithium titanium oxide, and hydrogen titanium oxide derived from lithium titanium oxide.

8. A method according to claim 1, wherein in the extraction step the feedstock solution is flown through both the bores and the volumes external to the hollow fibers.

9. A method according to claim 1, wherein in the release step the release solution is flown through both the bores and volumes external to the hollow fibers.

10. A method according to claim 8, wherein the release solution flows through the volumes external to the hollow fibers and then flows through the bores of the hollow fibers.

11. A method according to claim 1, wherein the feedstock solution has a pH>7.

12. A method according to claim 1, wherein the release solution has a pH<7.
